(19) United States
(12) Patent Application Publication
(10) Pub. No.: US 2026/0302973 A1
(43) Pub. Date: Oct. 1, 2026

(54) SYSTEM FOR OPERATING ELECTRIC MOTORS

(71) Applicant: In Motion AS, Gjerdsvika (NO)

(72) Inventor: Hallvard SLETTEVOLL, Gjerdsvika (NO)

(73) Assignee: In Motion AS, Gjerdsvika (NO)

(21) Appl. No.: 18/877,452

(22) PCT Filed: Jul. 5, 2023
(86) PCT No.: PCT/NO2023/060011

§ 371 Date: Dec. 20, 2024

(30) Foreign Application Priority Data
Jul. 7, 2022 (NO) 20220785

(51) Int. Cl. H02P 6/04; B63H 21/17; B63H 23/06; H02P 27/04

(52) U.S. Cl. CPC H02P 6/04; B63H 21/17; B63H 23/06; H02P 27/04

(57) ABSTRACT

The present invention relates to a power supply system and corresponding method for controlling rotating electric machines or motors, especially heavy machines such as ship motors. The system includes at least one motor driven by a three phase AC power supply. The system further comprises at least two parallel units connected to between the power supply and the motor, including a frequency controller configured to provide power within a chosen frequency range to provide a stepless control of the rotation speed of the motor, and a first switch, and also including a main controller connected to the frequency controller and the first switch. The system also includes a synchronization unit connected to the AC power supply and being configured to measure chosen parameters therein, including voltage, frequency and phase sequence for the AC power supply, the synchronization unit also being connected to frequency controller, where the frequency controller being configured to synchronize the power supplied to the motor to the measured parameters before connecting or disconnecting the parallel units.

The present invention relates to a system for operating electric motors, especially for controlling rotation speed and power in heavy machines, for example for propellers in ships.

Environment and climate are important aspects that have to be considered in most areas today. This is especially important in industry and transport by considering reduction in use of electric energy and fuel, and emissions that can hurt the environment. It is an object of the present invention to present a solution which contributes to efficient use of energy in large machines and in operating the machines in an energy efficient way by using components and assemblies of them so that start, stop and operation of the machines are performed with efficient use of energy and also reduction of emissions being harmful for the environment.

Existing solutions for handling this is discussed in U.S. Pat. Nos. 8,648,553 and 9,614,464, which describe efficient power regulation for a propeller, turbine or other rotating machines, in addition to U.S. Pat. Nos. 9,923,431 and 8,519,662, where soft start and control of the systems with a number of electric machines are discussed. US2015/3333686 describes the use of a current control system measuring the phase currents for controlling a rotating machine and EP2963806 describes the control of a converter using a 6 step control scheme.

A problem related to control of a multitude of machines is related to interruptions and non-continuous changes in the power supply. This is solved according to the present invention as specified in the accompanying claims.

As is evident from the claims a system is provided being suitable for seamless changes in the operation modes for example in motors, motor windings and gears in a drive system.

This is obtained by measuring the voltage, frequency and phase sequence in the AC power supply and adjusting the drive current being supplied to the motors before connecting or disconnecting the different switches controlling the power to the motors.

The present invention will be described below with reference to the accompanying drawings, illustrating the invention by way of examples.

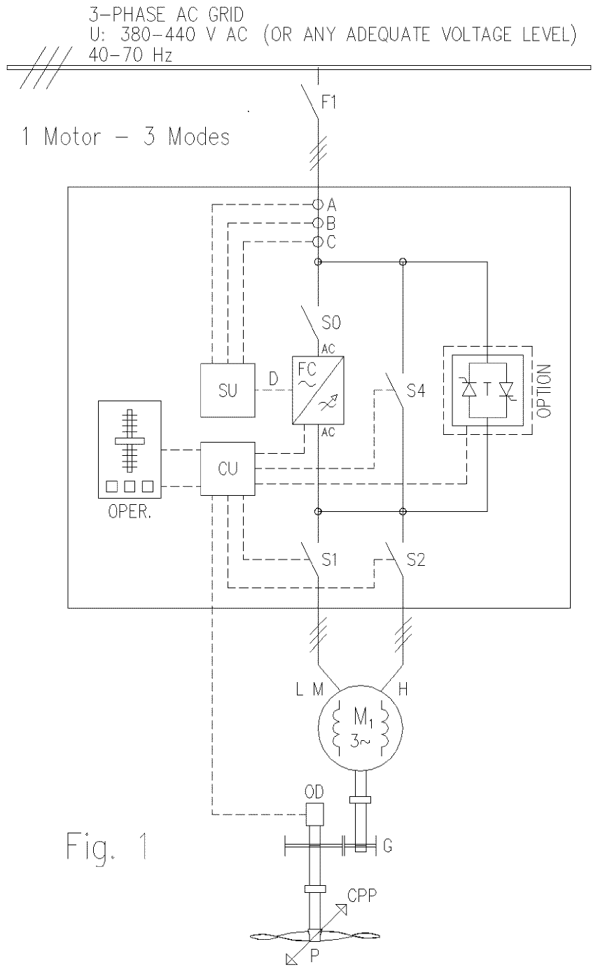

FIG. 1 illustrates a first embodiment of the invention.

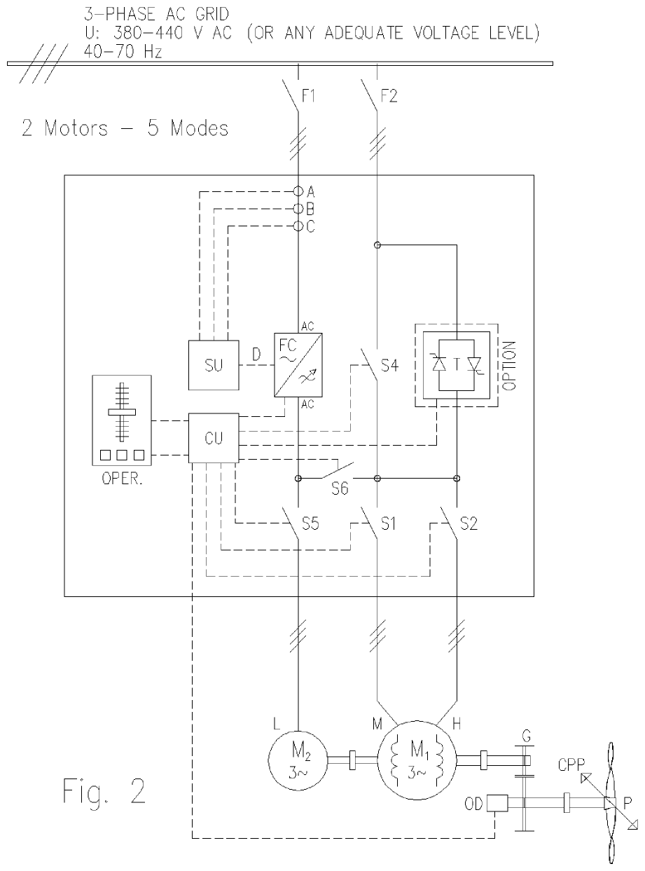

FIG. 2-7 illustrates additional embodiments of the invention.

As illustrated in FIG. 1 the preferred embodiment of the present invention relates to a three phase AC power supply such as an AC network, being used for controlling an electric motor M1 connected to the network with a switch F1, for example for driving a propeller P. The propeller will preferably have a controllable pitch (controllable pitch propeller—CPP) with a controllable angle for the slope of the propeller which can be adjusted stepless using an actuator OD. In the illustrated examples the embodiments are based on a 3 phase AC grid with voltage in the 380-440V range and a frequency range of 40-70 Hz, but other AC power supply types may also be contemplated.

FIG. 1 illustrates three parallel units connected to the power supply and the motor. The parallel units include a frequency converter or controller FC suitable for to and from coupling to the AC network is adapted to provide variable stepless rotation speed using a variable output frequency to the motor M1 and is coupled in parallel with a first switch S4 between the AC network and the motor M1. The frequency converter FC can be coupled to the AC network through a second switch SO, which will be connected when the frequency converter is in use and which may be replaced by a switch in the frequency converter. Through the first and second switch S4, SO it is therefore possible to connect the AC network directly, through the first switch S4, and/or through the frequency converter FC to the motor M1 (if the switches S1 or S2 are engaged).

The parallel units, e.g. the frequency converter FC and the first switch S4, are connected to different windings L, M, H in the motor M1 with a first and second motor current switches S1, S2 making it possible to provide different controlled speeds. The system may also include a control unit CU connected to through a control panel OPER, e.g. at the ship bridge, in order to facilitate control through the control unit CU, including the frequency converter, the first switch S4 and the motor current switches S1, S2, as well as the parallel coupled thyristor circuit T. This way the control unit may choose which of the parallel coupled units, the frequency converter, the first switch and/or which winding in the motor to be used etc to control the motor.

FIG. 1 also includes a synchronization unit SU being provided with sensors measuring the voltage (A), frequency (B), and phase sequence (C), for the power supplied by the three phase network at the coupling F1, and is connected to the frequency converter FC for providing signals corresponding to the measurements to the frequency controller, and where the frequency controller is configured to control the AC signal applied to the motor M1 based on them, thus being able to control the output voltage, frequency and phase sequence from the frequency controller to correspond directly to the measured values, and thus avoid transients etc.

If the control unit CU asks the system to change between the frequency converter FC, the first switch S4 and possibly the thyristor T the frequency converter may at its output adjust the voltage, frequency and/or phase to correspond to the voltage, frequency and phase A, B, C so that the transition evolves seamlessly when the switches are connected or disconnected. In other words the frequency converter FC will make sure the output form the frequency converter essentially corresponds to the measured parameters in the AC network so that the motor does not sense any transition from the frequency converter to the direct connection through the first switch S4.

According to the embodiment of the invention illustrated in FIG. 1 the frequency converter FC may be controlled by the control unit CU to operate in one of the following ways:
A: The frequency converter FC connected directly to the motor may seamlessly control the rotation speed/RPM in the electric motor M1 from zero to the maximum RPM. Given a fixed or variable thrust in a controllable pitch propellor CPP, or corresponding mechanical arrangement in the machine that can be regulated, the output or thrust of the machine may be a defined by the product of the RPM and CPP. If the RPM is zero the effect will be zero, and/or the CPP is set at zero, the effect will be zero as well.
B: Transferring load without transient currents from the frequency converter to the fist switch S4 or thyristor T, and back again depending on the situation. The process is based on exact measurements of the parameters voltage A, frequency B and phase sequence C from which the frequency converter control the adjustments. The load transfer is only done when the frequency controller FC, through the synchronization unit SU confirms that the parameters correspond to the output of the frequency converter to the motor M1 so that the motor at the transition to the first switch S4 does not experience any difference in the parameters during the transition.
C: The frequency controller FC may also adjust the output into the motor when it is run through the first switch S4 and either the first S1 or second S2 motor switches, connected to windings M and H respectively, to a controlled RPM using the frequency of the frequency controller output.

In FIG. 1 an additional option is shown including the connection of a thyristor in parallel with the first switch S1 and the frequency controller with related second switch SO, which provides some additional functions:
D: The thyristor may take over if the first switch S4 fails. The thyristor will then be able to operate as a static switch for the load.
E: If the frequency converter FC should fail the thyristor may accelerate the motor M1 carefully to its nominal RPM and get the process machinery up to normal operation again. The effect will then be regulated by the actuator OD between 0 and 100% load.

As mentioned above the RPM of the motor M1 may be regulated in steps by choosing windings with different pole numbers and/or by choosing which electric motor is connected if there are more than one.

According to the invention the system may be provided with a gear G with at least one exchange ratio, possibly in steps. By choosing one of the available gear exchanges the RPM of the propellor may be regulated in steps, while also optimizing the outgoing momentum or torque.

The power sources supplying the system with power may also be controlled by providing variable frequency, for example as stated in the illustrated examples, in the range of 40 to 70 Hz. This variation may, as discussed above, be measured by the synchronization unit SU controlling the frequency converter FC.

Variable supply frequency will therefore affect the RPM of the process machines or propellors P when for example the one of the motor switches S2 and the first switch S4 are activated, resulting in that the electric motor M1 is fed directly without the frequency converter converting from the AC supply network. The supplied frequency will in this case therefore function partially in the same way as if the motor M1 is controlled through the frequency converter FC.

As mentioned above the variable slope CPP of the process machine/propeller P may adjust the generated and consumed effect steplessly.

Depending on the design of the propellor or process machine P the energy consumption and performance may also be regulated internally in the machine by changing for example the slope or angle of the propeller blades or shovels by pitch regulation. Some machines will in this way regulate within a positive effect curve, often form 0-100%, while other machine types may be regulated from −100%, through zero, to +100% performance, given that the machine is run at a nominal RPM.

The operation panel OPER may provide a command concerning the available alternative modes of operation of system, for example one or more of the one mentioned above, depending on how many winding systems are available in chose electric motors M1, M2, M3 etc with corresponding switches and similar, as illustrated in FIGS. 2-7.

With one winding in the motor M1 there will be two operation modes L, M where the system only operates through the first motor switch S1 and the frequency controller FC.

With two coils/windings in M1, as illustrated in FIG. 1, there will be two operation modes being driven by the frequency converter FC and/or the second switch S4, through the motor switches S1, S2.

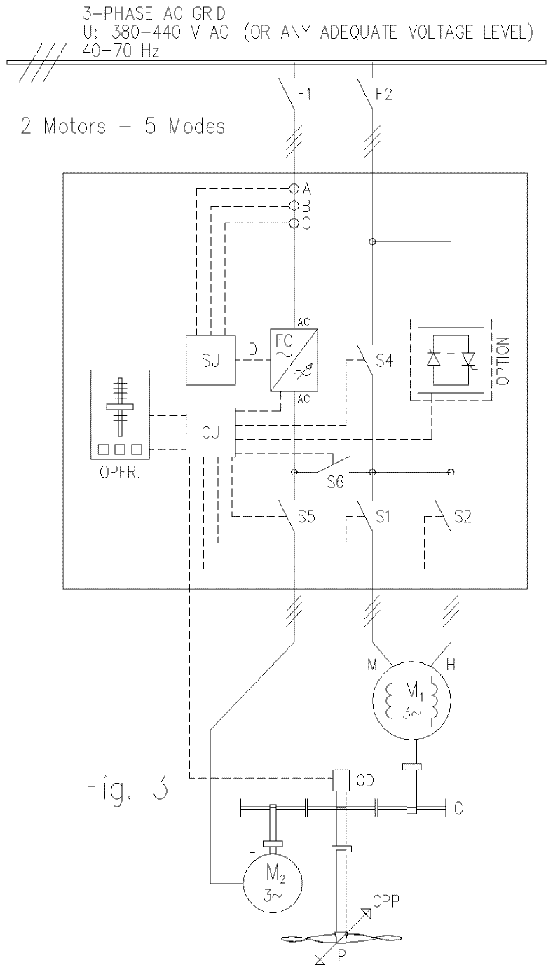

With three windings, as illustrated in FIG. 3, the windings are places in two motors M1, M2 connected to the same propeller P and pitch control CPP, there will be four modes of operation for the system.

An advantage with the system according to the invention is the ability to achieve efficient operations with minimal electric loss and compact size. This will provide a robust system with a long lifespan.

Redundancy is also an important feature of the system. One or more errors will not leave the system without power but may, for example, if the frequency converter fails, may be driven through the first switch S4, with support from the pitch control CPP.

FIG. 1 shows the system with a physical electric machine (motor M1 or generator) primarily of an asynchronous type. In this configuration the system may have the following operation, power modes:
LOW: RPM regulated by the frequency converter FC alone, with second switch S0 and first motor switch activated, and first switch S4 and thyristor T passive.
   Power is a product of the variable RPM and thrust from the pitch control in percent.
   Maximum power is given by the capacity of the frequency controller, switches S0, S1 and winding M in the motor M1.
   As an alternative the frequency converter can by used while activating switches S0 and S2. This provides higher output effect through winding H, which is dimensioned for 100% power.
MEDIUM: RPM is given by the medium motor winding M.
   Power is controlled by the pitch control alone. Maximum power is given by the capacity of the related switches S1, S4 and the coil winding M.
HIGH: RPM is given by the use of the high RPM winding H in the motor M1
   Power is regulated by the pitch control CPP alone. Constant full RPM is given by the pole number in the high RPM winding H.
   Maximum power is given by the capacity of the relevant switches S2, S4 and the high RPM winding H.

The high and medium RPM windings H, M may in this system be H: 4 pole 1800 RPM and M: 6 pole 1200 RPM.

As mentioned above the use of a thyristor T connected in parallel with the frequency converter and first switch is an option. Using the thyristor unit T falls within a consideration of the necessity for an extra redundancy as it may replace the frequency controller FC or first switch S4 in an emergency.

FIG. 2 illustrates a system according to the invention with two physical electric machines (motor or generator) primarily of an asyncronic type where the first machine has two windings M, H and the second machine M2 has a low RPM winding L. The machines M1,M2 are connected to a shaft and through a gear G to a propeller P.

In FIG. 2 the frequency controller, the second switch S0 and possibly the thyristor connected through the motor power switches S1, S2 to the first motor M1. In addition, the second motor M2 is connected to them through a third motor power switch S5 and an additional switch S6 may be used to separate the frequency controller FC and the second motor M2 from the first switch S4, thyristor T and the first motor M1. The frequency controller FC is connected through the additional switch S6 to the first switch S4 and the first and second motor power switches S1, S2. As in FIG. 1 a thyristor T may be connected in parallel to the first switch and the frequency controller.

In the configuration in FIG. 2 the system may operate in the following operation modes.
LOW: RPM is regulated by the frequency controller alone, where the frequency controller and third motor power switch S5 are active and first and second motor power switches S1, S2 as well as first switch S4, additional switch S6 and thyristor T are passive.
   The power is a product of the variable RPM and the pitch control CPP percentage.
   Maximum power is given by the capacity of the frequency controller, third motor power switch S5 and the winding in the second motor M2.
   Three different alternatives may then be used for the LOW operation:
   Connecting the third switch S5 which connects the frequency controller to the low L winding in the second motor M2
   Connecting the additional switch S6 and first motor switch S1, thus connecting the frequency controller FC to the medium winding M in the first motor M1.
   Connecting the frequency controller FC through the additional switch S6 and second motor switch S2 to the high RPM winding H in motor M1.
MEDIUM: In the medium power mode the RPM is given by the use of the medium coil winding M in the first motor M1.
   The power is regulated using the pitch control CPP and the first switch S4 is directly connected to the AC network through a switch F2, and thus the frequency controller is not connected to the medium winding M in the first motor M1. The RPM is given by the pole number in the medium winding M in the first motor M1.
   Maximum power is given by the capacity of the first motor switch S1 and medium winding M, as well as the percentage of the pitch control thrust.
   The solution also includes a boost functionality where the effect of M1 may be used by torque regulation in the frequency controller applies a force through the second motor M2 while the first motor is driven at a fixed RPM. The maximum power will then be given by the sum of the second motor M2 and the medium motor winding M in the first motor M1.
HIGH: RPM is given by the use of the high winding H in the first motor M1.
   The power is regulated through the pitch control since the frequency controller is not connected. Constant full RPM is given by the pole number in the high winding H.
   Maximum power is given by the capacity of S2 and winding H, as well as the pitch control.
   In addition a boost functionality may be provided where the first motor M1 is supplied with momentum or torque regulation by using the frequency controller to apply an effect through the second motor M2 while the first motor M1 drives at a constant RPM. The maximum power will then be given by the second motor M2 and the high winding H in the first motor M1, in addition to the controlled pitch CPP.

In FIG. 3 an alternative embodiment is shown corresponding to the embodiment shown in FIG. 2, where the motors M1, M2 have a different connection to the propeller. This improves the redundancy of the system since the motors M1, M2 are independent of each others axles, being connected through the gear G to the propeller.

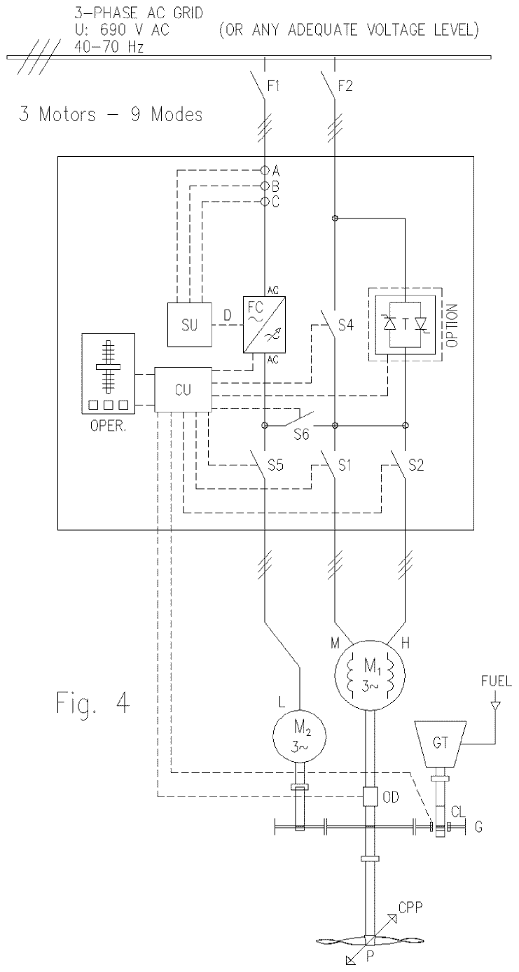

FIG. 4 illustrates a similar system as in FIG. 2, where a fuel driven turbine GT is added connected directly to the propeller P with pitch control CPP through a gear G. The turbine and its contribution is controlled through the rest of the system from the control unit CU.

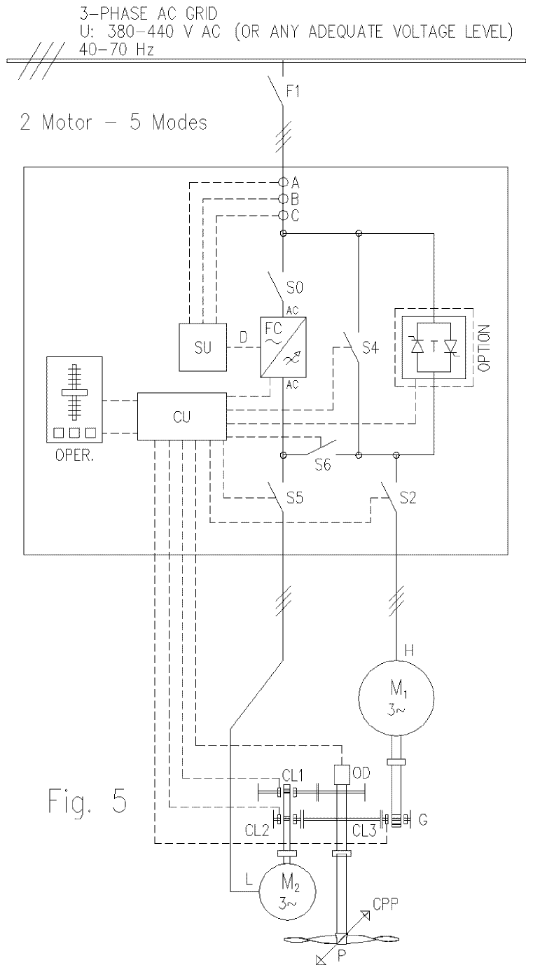

FIG. 5 illustrates an embodiment where the medium winding M in the first motor M1, and corresponding first switch S1, is replaced by a gear system with at least two controllable clutches, CL1, CL2, CL3.

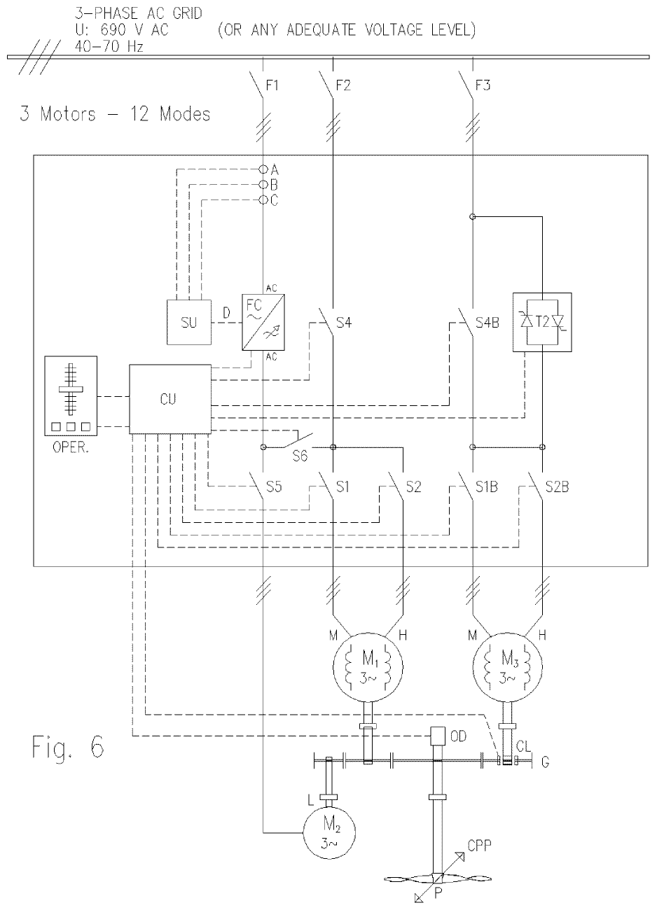

FIG. 6 illustrates an embodiment of the system illustrated in FIG. 3, but provided with an additional third motor M3, connected through corresponding switches S1B, S2B, S4B with a third connecting switch F3 to the AC network.

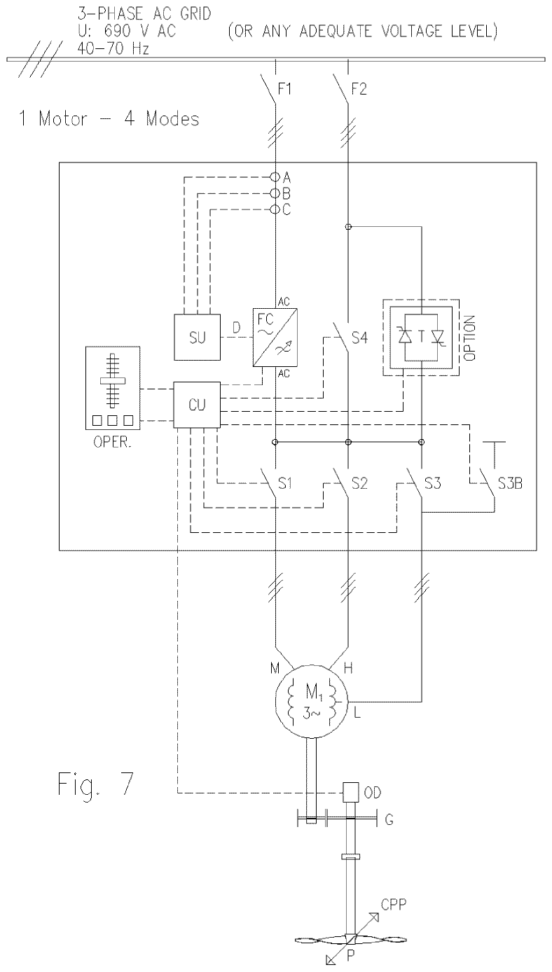

FIG. 7 illustrates an embodiment corresponding to the embodiment illustrated in FIG. 1, also including a low RPM winding L in the first motor M1. The low winding may be reconfigured from the high winding. Low provides half the RPM of the high RPM winding when reconfigured using the switches S3 and S3B. The embodiment in FIG. 7 thus being configured to provide three different RPMs from the first electric machine or motor M1.

To summarize the present invention relates to a power supply system for controlling rotating motors or machines, especially heavy machines on ships or sea vessels. The system includes at least one motor M driven by a three phase AC power supply unit or network. The system comprises at least two parallel unit connected between the power supply and the motor, including a frequency controller or converter FC being configured to provide power with a steplessly regulated frequency to at least one motor for providing a stepless control over the rotation speed of the motor. The parallel units also includes a first switch S4 connected in parallel with the frequency controller to the AC network and the motor, and a main controller connected and/or communicating with the frequency controller and the first switch.

The system also includes a synchronization unit SU connected to the AC network and being configured to measure chosen parameters, including voltage A, frequency B and phase sequence in the AC-network, where the synchronization unit is connected or at least communicates with the frequency controller. The frequency controller is adapted to synchronize the power supplied to the motor or motors to the parameters A, B, C before connecting or disconnecting the parallel connected units, such as the frequency controller FC, the first switch S4 and possibly a thyristor T.

The system may also comprise a main control which is also connected to at least one gear system which is coupled to the motor. The system may also include a thyristor connected in parallel with the frequency controller and the first switch, where the thyristor is also connected to the main control.

The system thus has at least two parallel units, at least one of which being a frequency controller and at least one switch, being connected between an AC power supply and an electric machine or motor, and may be run according to a method including the following steps:
Sensing the voltage, frequency and phase sequence in the AC network.
Adjusting the output of a frequency controller so as to correspond to the measured parameters.
Connecting or disconnecting the parallel units.

### Symbol Explanations

OPER Control panel for controlling power and RPM
A Sensor for measuring voltage from the power supply, in volts.
B Sensor for measuring frequency from the power supply, in Hz.
C Sensor for measuring the phase sequence from the three phase
grid network.
SU SYNCHRONIZATION CONTROL UNIT
D Signal transmitting the measured values of A, B, C from the SU to the FC
FC Frequency converter or controller of a per se known type.
CU Control unit, with relevant software.
F1-F5 Current switch with overload protection.
S1-S12 Current switch, controlled.
T, T1-T4 Thyristor bridge, three phase controlled.
M1-M4 Electric motor or generator with at least one winding.
L, M, H Windings in motor, Low, Medium and High, with different pole numbers
OD Actuator controlling the pitch angle of the propeller.
CL, CL1, CL2, CL3 Clutch—remote controlled or automatic.
G Gearbox
GT Turbine, e.g. gas turbine
CPP adjustable pitch angle or load characteristic
P Process machine, propeller

1-4. (canceled)

5. A power supply system for controlling rotating electric machines or motors comprising a propellor, especially heavy machines such as ship motors, the power supply system comprising:
at least one motor driven by a three phase AC power supply;
at least two parallel units connected to between the power supply and the motor, comprising a frequency controller configured to provide power within a chosen frequency range to provide a stepless control of the rotation speed of the motor, and a first switch, and also comprising a control unit connected to the frequency controller and the first switch:
a synchronization unit connected to the AC power supply and being configured to measure chosen parameters therein, comprising voltage, frequency and phase sequence for the AC power supply, the synchronization unit also being connected to frequency controller, the frequency controller being configured to synchronize the power supplied to the motor to the measured parameters to a predetermined RPM before connecting or disconnecting the parallel units; and
wherein the propellor comprises a pitch control adjusting the thrust of the machine and wherein the control unit is connected to the pitch control and configured to adjust the pitch of the propellor, the thrust thus being related both to the RPM and propellor pitch.

6. The power supply system according to claim 5, wherein the main controller is connected to at least one gear system coupled to the motor.

7. The power supply system according to claim 5, wherein the parallel units include a thyristor T connected to the main control.

8. The power supply system according to claim 5, wherein the at least one motor includes at least two different windings, each providing different RPM, the control unit being configured to connect the selected windings to the power supply through at least one of the parallel units.

9. The power supply system according to claim 5, wherein:
the propellor is connected to the at least one motor through a gear; and
the gear is controlled through the control unit.

10. A method for controlling a power supply system according to claim 5, the method comprising:
measuring parameters of voltage, frequency, and phase sequence in the AC power supply;
adjusting the output signal from the frequency controller so as to correspond to the measured parameters; and
connecting or disconnecting one or more of the parallel units.

11. A method for controlling a power supply system according to claim 5, the method comprising:
with the frequency controller connected to the power supply and the motor, increasing the thrust using the frequency controller and/or propellor pitch control;
at a predetermined thrust or RPM adjusting the output signal of the frequency controller so as to correspond to the parameters of the AC power supply; and
disconnecting the frequency controller and connecting the AC power supply directly to the motor.

12. A method for controlling a power supply system according to claim 5, the method comprising:
at a predetermined thrust or RPM adjusting the output signal of the frequency controller so as to correspond to the parameters of the AC power supply;
with the frequency controller connected to the power supply and the motor, increasing the thrust using the frequency controller and/or propellor pitch control; and
connecting the frequency controller to motor and disconnecting the AC power supply from the motor.
